(19) United States
(12) Patent Application Publication
(10) Pub. No.: US 2026/0161440 A1
(43) Pub. Date: Jun. 11, 2026

(54) HOST-BASED INTERACTIVE COMMAND LINE ENVIRONMENT FOR COMMUNICATING WITH A VIRTUAL MACHINE

(71) Applicant: Red Hat, Inc., Raleigh, NC (US)

(72) Inventors: Debarshi Ray, Brno (CZ); Felipe Vieira Borges, Brno (CZ)

(21) Appl. No.: 18/977,569

(22) Filed: Dec. 11, 2024

(51) Int. Cl. G06F 9/455

(52) U.S. Cl. CPC G06F 9/45558; G06F 2009/45579

(57) ABSTRACT

An application receives, via a host command line shell that executes on a host computing device and interfaces with a terminal user interface (UI), an indication to provide, to the terminal UI, a virtual machine (VM) command line shell prompt associated with a VM command line shell implemented by a VM. The application establishes, with the VM, a communication session. The application receives, from the VM via the communication session, the VM command line shell prompt. The application presents, in the terminal UI, the VM command line shell prompt.

### BACKGROUND

Individuals, such as software developers, may utilize a virtual machine (VM) to isolate changes to aspects of the VM, such as changes to a file system of the VM, from the host computing device on which the VM executes.

### SUMMARY

The examples disclosed herein implement a host-based interactive command line environment for interacting with a virtual machine.

In one implementation a method is provided. The method includes receiving, via a host command line shell that executes on a host computing device and interfaces with a terminal user interface (UI), by an application executing on the host computing device, a first indication to provide, to the terminal UI, a first virtual machine (VM) command line shell prompt associated with a first VM command line shell implemented by a first VM. The method further includes establishing, by the application with the first VM, a first communication session. The method further includes receiving, by the application from the first VM via the first communication session, the first VM command line shell prompt. The method further includes presenting, by the application in the terminal UI, the first VM command line shell prompt.

In another implementation a host computing device is provided. The host computing device includes a memory, and a processor device coupled to the memory to receive, via a host command line shell that executes on the host computing device that interfaces with a terminal user interface (UI), by an application executing on the host computing device, a first indication to provide, to the terminal UI, a first virtual machine (VM) command line shell prompt associated with a first VM command line shell implemented by a first VM. The processor device is further to establish, by the application with the first VM, a first communication session. The processor device is further to receive, by the application from the first VM via the first communication session, the first command line shell prompt. The processor device is further to present, by the application in the terminal UI, the first VM command line shell prompt.

In another implementation a non-transitory computer-readable storage medium is provided. The non-transitory computer-readable storage medium includes executable instructions to cause a processor device to receive, via a host command line shell that executes on the host computing device that interfaces with a terminal user interface (UI), by an application executing on the host computing device, a first indication to provide, to the terminal UI, a first virtual machine (VM) command line shell prompt associated with a first VM command line shell implemented by a first VM. The instructions further cause the processor device to establish, by the application with the first VM, a first communication session. The instructions further cause the processor device to receive, by the application from the first VM via the first communication session, the first command line shell prompt. The instructions further cause the processor device to present, by the application in the terminal UI, the first VM command line shell prompt.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIGS. 1A-1C are block diagrams of an environment in which a host-based interactive command line environment for communicating with a virtual machine can be practiced according to some implementations;

FIG. 2 is a flowchart of a method for implementing a host-based interactive command line environment for communicating with a virtual machine according to some implementations;

FIGS. 3A-3B illustrate a message sequence diagram illustrating messages communicated between and actions taken by certain components illustrated in FIGS. 1A-1C to implement a host-based interactive command line environment for communicating with a virtual machine according to some implementations;

FIG. 4 is a simplified block diagram of the environment illustrated in FIGS. 1A-1C according to one implementation; and

FIG. 5 is a block diagram of the host computing device suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

A virtual machine is an environment on a host computing device (e.g., a bare metal machine), that emulates a physical machine. A virtual machine runs a guest operating system, such as Linux, Windows®, or the like, that is separate from the operating system running on the host computing device. A virtual machine monitor, sometimes referred to as a hypervisor, coordinates access to physical resources of the host computing device, such as memory and processor devices, by the virtual machines running on the host computing device. A virtual machine creates an isolated environment such that even the guest operating system may be unaware that there are processes running outside of the virtual machine and typically events that occur in the virtual machine, even if severe enough to bring down the virtual machine, will not affect the host computing device or other virtual machines running on the host computing device.

While virtual machines are used for many purposes, software developers may utilize a virtual machine to isolate revisions and changes made to core operating system components, such as, by way of non-limiting example, the operating system kernel, from that of the host computing device on which the virtual machine executes.

Graphical user interface (GUIs) front-ends exist, such as VirtualBox and Gnome, via which a software developer can access a virtual machine. However, different virtual machine technologies require different GUI front-ends, and each GUI front-end appears somewhat differently from other GUI front-ends, causing significant cognitive overhead for a software developer utilizing multiple virtual machines to support multiple operating systems. Moreover, such GUI front-ends typically provide a desktop background which the developer does not need but contributes to cognitive overhead as the developer moves from GUI front-end to GUI front-end.

The examples disclosed herein implement a host-based interactive command line environment for interacting with a virtual machine. The examples eliminate a need for a virtual machine GUI to interface with a virtual machine, and allow the developer to interact with multiple virtual machines using the command line prompt shell in a terminal window user interface of the host computing system. The examples allow multiple terminal window user interfaces to be initiated, wherein each such terminal window user interface may be utilized to interact with a different virtual machine. Alternatively, the examples allow a single terminal window user interface to be used to access multiple different virtual machines. Irrespective of the guest operating system of the virtual machine, the examples provide a consistent text-based user interface that is substantially identical across different operating systems. The examples eliminate the need for the developer to navigate different bit-mapped graphics of different virtual machine desktops in order to support, for example, multiple operating systems, reducing cognitive overhead and allowing for more efficient analysis and software development.

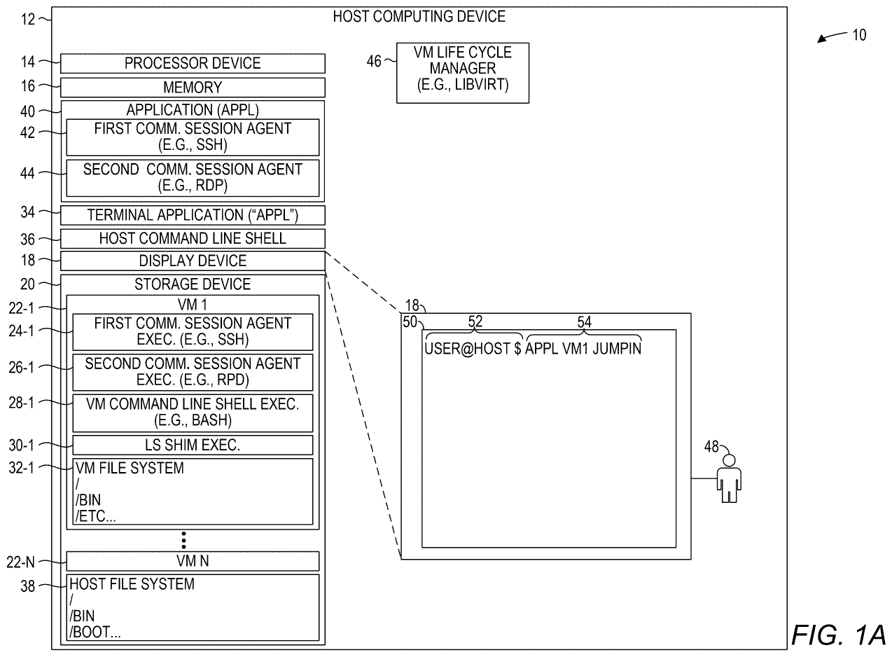

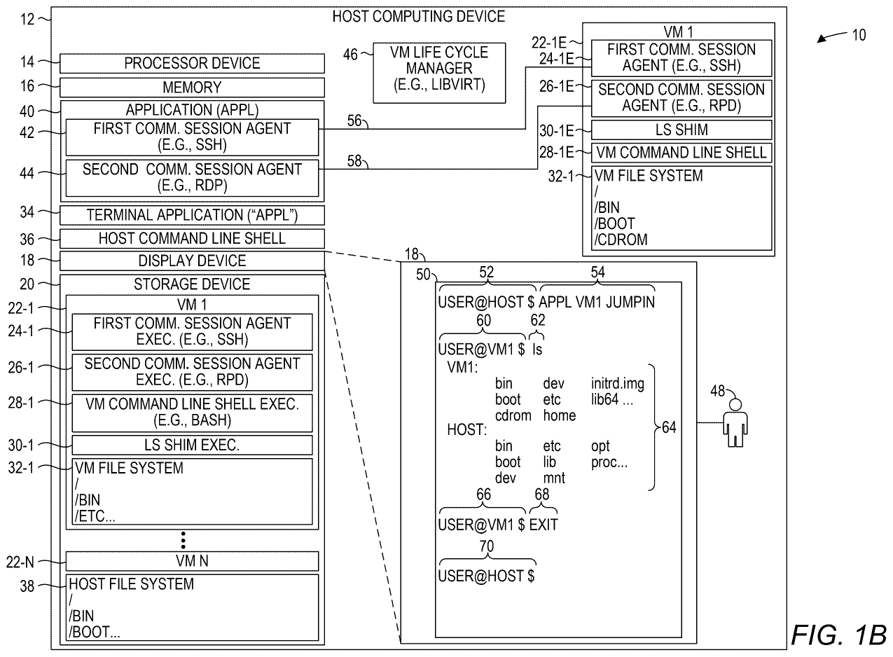

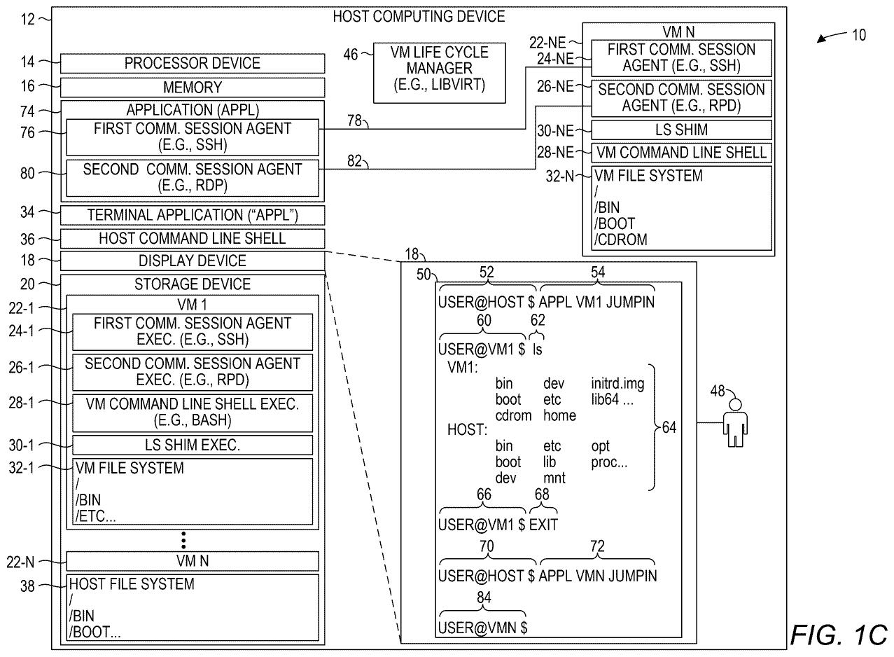

FIGS. 1A-1C are block diagrams of an environment 10 in which a host-based interactive command line environment for interacting with a virtual machine can be practiced according to some implementations. Referring first to FIG. 1A, the environment 10 includes a host computing device 12 that in turn includes a processor device 14, a memory 16, and a display device 18. The host computing device 12 includes or is communicatively coupled to a storage device 20. A plurality of virtual machines (VMs) 22-1-22-N (generally, VMs 22) may be stored on the storage device 20. The VM 22-1 has been generated to include a first communication session agent executable 24-1. The first communication session agent executable 24-1 may comprise, for example, a text-based communication agent, such as, by way of non-limiting example, an SSH agent. The VM 22-1 may also be generated to include a second communication session agent executable 26-1. The communication session agent executable 26-1 may be, for example, a graphics-capable communication agent, such as, by way of non-limiting example, a Remote Desktop Protocol (RDP) agent. While the VM 22-1 is illustrated as having the two communication session agent executables 24-1, 26-1, the examples disclosed herein may be implemented with a single communication session agent.

The VM 22-1 includes a VM command line shell executable 28-1 that is a command processor that executes various commands, such as Linux commands and the like. In some implementations, the VM command line shell executable 28-1 comprises the Bash command processor, but the examples disclosed herein are not limited to any particular command line shell. In some implementations the VM 22-1 includes an LS shim executable 30-1 that is operable to intercept a Linux LS command and implements the conventional LS command and supplemental functionality, as will be described in greater detail below. The VM 22-1 includes a VM file system 32-1 that contains OS files, user files, application files, and any other files necessary to implement the desired functionality of the VM 22-1. Although illustrated separately for purposes of illustration, the first communication session agent executable 24-1, the second communication session agent executable 26-1, the VM command line shell executable 28-1, and the LS shim executable 30-1 may be executable files stored in the VM file system 32-1. The VM 22-N may be similarly configured to the VM 22-1. The VM 22-N may implement a different distribution than the VM 22-1 and thus the file system of the VM 22-N may differ from the file system of the VM 22-1.

The host computing device 12 includes a terminal application 34 and a host command line shell 36 that is a command processor that executes various commands, such as Linux commands and the like. The terminal application 34 implements a text-based user interface (UI) that emulates a text-based terminal used to communicate with mainframe computers prior to the innovation of the GUI. The terminal application 34 presents textual information on the display device 18 and may be devoid of bit-mapped graphics. In some implementations, the host command line shell 36 comprises the Bash command processor, but the examples disclosed herein are not limited to any particular command line shell. In some implementations the terminal application 34 and the host command line shell 36 may be integrated into a single application.

The host computing device 12 has a host file system 38. The host file system 38 contains OS files, user files, application files, and any other files necessary to implement the desired functionality of the host computing device 12. The OS of the host computing device 12 and the VM 22-1 may differ.

The host computing device 12 includes an application 40 that includes a first communication session agent 42 that is operable to communicate with a first communication session agent that has been initiated from the first communication session agent executable 24-1, such as, by way of non-limiting example, an SSH agent. The application 40 may also include a second communication session agent 44 that is operable to communicate with a second communication session agent that has been initiated from the second communication session agent executable 26-1, such as, by way of non-limiting example, an RDP agent.

The host computing device 12 includes a VM life cycle manager 46 that is operable to handle VM orchestration, including starting, booting, stopping VMs and the like. In some implementations the VM life cycle manager 46 comprises the libvrt VM life cycle manager, but the implementations described herein are not limited to any particular VM life cycle manager.

With this background an example of a host-based interactive command line environment for communicating with a virtual machine according to one implementation will be discussed. Assume that the terminal application 34 has been initiated. The terminal application 34 presents, on the display device 18, a terminal user interface (UI) 50. The terminal UI 50 is a text-based user interface and may be devoid of bit-mapped graphics. The terminal application 34 may be configured to use the host command line shell 36 or the user 48 may enter a suitable command to execute the host command line shell 36 via the terminal UI 50. The host command line shell 36 interfaces with the terminal UI 50 and is operable to receive user input entered, such as by a keyboard, into the terminal UI 50. The host command line shell 36 is also operable to present information to the user 48 via the terminal UI 50. The host command line shell 36 may comprise, for example Bash, or any other suitable command line shell.

The host command line shell 36 presents a host command line shell prompt 52 in the terminal UI 50. File system commands submitted by the user 48 that are processed by the host command line shell 36 are processed with respect to the environment of the host computing device 12 rather than that of any VMs executing on the host computing device 12. For example, if the host computing device 12 is running a Linux OS and the user 48 submits a LS command to the host command line shell 36, the LS command will access the host file system 38 rather than the VM file system 32-1 and present the directories and files of the host file system 38 in the terminal UI 50.

In this example, the user 48 submits user input 54 in the terminal UI 50 adjacent to the host command line shell prompt 52 and presses the Enter key to cause the user input 54 to be processed by the host command line shell 36. The user input 54 is a request to execute the application 40 (i.e., “APPL”). The user input 54 includes an identifier of the VM 22-1 (i.e., “VM1”) and in this example a command for the application 40 to process, “JUMPIN”. The host command line shell 36 receives the user input 54 submitted in the terminal UI 50 adjacent to the host command line shell prompt 52. In response to receiving the user input 54, the host command line shell 36 initiates the application 40 and provides the application 40 the identifier of the VM 22-1, VM1, and the command to process, JUMPIN. The JUMPIN command is an indication to the application 40 to provide a VM command line shell prompt associated with a VM command line shell implemented by the VM 22-1 to allow the user 48 to submit commands to the VM 22-1 via the terminal UI 50. The initiation of the application 40 by the host command line shell 36 transfers control of the terminal UI 50 to the application 40 such that the application 40 can now present information in the terminal UI 50 and receive data via the terminal UI 50.

In this example, the application 40 determines that the VM 22-1 is not running on the host computing device 12 and is stored on the storage device 20. In other examples, the application 40 may have first been invoked to initiate a running VM from the VM 22-1, such as by submitting a suitable command to the host command line shell 36 via the terminal UI 50, such as “APPL VM1 INITIATE”.

Referring now to FIG. 1B, the application 40 causes an executing VM 22-1E to be initiated from the VM 22-1. In this example, the application 40 sends a command, such as via an application programming interface, to the VM life cycle manager 46 to initiate the VM 22-1E from the VM 22-1. The VM life cycle manager 46 starts the VM 22-1E from the VM 22-1. The VM 22-1E includes the VM file system 32-1. The VM 22-1E initiates and may automatically initiate a first communication session agent 24-1E from the first communication session agent executable 24-1, a second communication session agent 26-1E from the second communication session agent executable 26-1E, and a LS shim 30-1E from the LS shim executable 30-1.

The first communication session agent 42 establishes a first communication session 56 with the first communication session agent 24-1E. In this example the first communication session 56 is a text-based communication session, such as, by way of non-limiting example, an SSH communication session. In some examples, the second communication session agent 44 establishes a second communication session 58 with the second communication session agent 26-1E. In this example the second communication session 58 is a graphics-capable communication session, such as, by way of non-limiting example, an RDP communication session.

The establishment of the first communication session 56 may cause the initiation of a VM command line shell 28-1E from the VM command line shell 28-1. In other examples, the VM command line shell 28-1E may be initiated automatically as the VM 22-1E boots up. In other examples, the application 40 may send an instruction to the VM 22-1E to cause the VM command line shell 28-1E to be initiated from the VM command line shell 28-1.

The application 40 receives, from the VM 22-1E via the first communication session 56 a VM command line shell prompt 60. The application 40 presents the VM command line shell prompt 60 in the terminal UI 50. Note that the VM command line shell prompt 60 is presented concurrently with and below the host command line shell prompt 52 in the terminal UI 50.

The user 48 may now submit commands to the VM 22-1E via the terminal UI 50. In this example, the user 48 enters user input 62 adjacent to the VM command line shell prompt 60 and presses the enter key. The user input 62 comprises the Linux LS command. The application 40 receives the user input 62 and sends the user input 62 to the VM 22-1E via the first communication session 56. The VM command line shell 28-1E receives the LS command and executes the LS command on the VM 22-1E. In this example, the LS shim 30-1F intercepts the LS command. The LS shim 30-1F interacts with the second communication session agent 26-1E to cause the second communication session agent 26-1E to send a request, via the second communication session 58, to the application 40 to obtain the directory names of the host file system 38 of the host computing device 12. The LS shim 30-1F also executes the conventional LS command on the VM 22-1E to obtain the directory names of the VM file system 32-1 of the VM 22-1E.

The application 40 receives the request to obtain the directory names of the host file system 38 of the host computing device 12. The application 40 runs the LS command on the host computing device 12 to obtain the directory names of the host file system 38 of the host computing device 12. The application 40 sends the directory names of the host file system 38 of the host computing device 12 to the VM 22-1E via the second communication session 58. The LS shim 30-1F generates information that identifies the directory names of the VM file system 32-1 of the VM 22-1E and identifies the directory names of the host file system 38 of the host computing device 12. The LS shim 30-1F returns the information to the application 40 via the first communication session 56. The application 40 receives the information from the VM 22-1E and presents the information as file directory information 64 in the terminal UI 50. Note that the information is presented below and concurrently with the VM command line shell prompt 60.

Subsequent to receiving the information from the VM 22-1E the application 40 receives the VM command line shell prompt from the VM 22-1E and presents a VM command line shell prompt 66 in the terminal UI 50. The user 48 may now enter additional commands that will be processed by the VM 22-1E.

In this example, the user 48 submits user input 68 in the terminal UI 50 adjacent to the VM command line shell prompt 66 and presses the Enter key to cause the user input 68 to be processed by the VM command line shell 28-1E. The user input 68 is an EXIT command that is a request to end the VM command line shell 28-1E and inhibit further communication with the VM 22-1E via the terminal UI 50. The application 40 receives the user input 68 and sends the user input 68 to the VM 22-1E via the first communication session 56. The VM command line shell 28-1E receives the EXIT command and terminates. The application 40 terminates the first communication session 56 and the second communication session 58. The application 40 may send a command to the VM life cycle manager 46 to terminate the VM 22-1E. In other implementations the EXIT command may merely end the session with the application 40 and the VM 22-1E may continue executing.

The application 40 terminates, returning control of the terminal UI 50 to the host command line shell 36. The host command line shell 36 presents a host command line shell prompt 70 in the terminal UI 50.

Referring now to FIG. 1C, the user 48 submits user input 72 in the terminal UI 50 adjacent to the host command line shell prompt 70 and presses the Enter key to cause the user input 72 to be processed by the host command line shell 36. The user input 72 is a request to execute the application APPL. The user input 72 includes an identifier of the VM 22-N (i.e., “VMN”) and in this example a command for the application 40 to process, “JUMPIN”. The host command line shell 36 receives the user input 72 submitted in the terminal UI 50 adjacent to the host command line shell prompt 70. In response to receiving the user input 54, the host command line shell 36 initiates an application 74 from the same executable as the application 40 in the host file system 38, and provides the application 74 the identifier of the VM 22-N, VMN, and the command to process, JUMPIN. The application 74 implements the same functionality as the application 40. As discussed above, the JUMPIN command is an indication to the application 74 to provide a VM command line shell prompt associated with a VM command line shell implemented by the VM 22-N to allow the user 48 to submit commands to the VM 22-N via the terminal UI 50. The initiation of the application 74 by the host command line shell 36 transfers control of the terminal UI 50 to the application 74 such that the application 74 can now present information in the terminal UI 50 and receive data via the terminal UI 50.

In this example, the application 74 determines that the VM 22-N is not running on the host computing device 12 and is stored in the storage device 20. The application 74 causes an executing VM 22-NE to be initiated from the VM 22-N. In this example, the application 74 causes the VM 22-NE to be initiated by sending a command to the VM life cycle manager 46 to initiate the VM 22-NE from the VM 22-N. The VM life cycle manager 46 starts the VM 22-NE from the VM 22-N the VM 22-N includes the VM file system 32-1. The VM 22-NE initiates and may automatically initiate a first communication session agent 24-NE from a first communication session agent executable of the VM 22-N, a second communication session agent 26-NE from a second communication session agent executable of the VM 22-N, and a LS shim 30-NE from an LS shim executable of the VM 22-N.

A first communication session agent 76 establishes a first communication session 78 with the first communication session agent 24-NE. In this example the first communication session 56 is a text-based communication session, such as, by way of non-limiting example, an SSH communication session. In some examples, a second communication session agent 80 establishes a second communication session 82 with the second communication session agent 26-NE. In this example the second communication session 82 is a graphics-capable communication session, such as, by way of non-limiting example, an RDP communication session.

The establishment of the first communication session 78 may cause the initiation of a VM command line shell 28-NE from a VM command line shell of the VM 22-N. In other examples, the VM command line shell 28-NE may be initiated automatically as the VM 22-NE boots up. In other examples, the application 74 may send an instruction to the VM 22-NE to cause the VM command line shell 28-NE to be initiated from the VM command line shell of the VM 22-N.

The application 74 receives, from the VM 22-NE via the first communication session 78 a VM command line shell prompt 84. The application 74 presents the VM command line shell prompt 84 in the terminal UI 50. Note that the VM command line shell prompt 84 is presented concurrently with and below the host command line shell prompt 52 in the terminal UI 50, as well as below and concurrently with the VM command line shell prompt 66. The user 48 may now submit commands to the VM 22-NE via the terminal UI 50. Such commands will be processed by the application 74 and the VM 22-NE as discussed above with respect to the application 40 and the VM 22-1E.

It is noted that, because the applications 40, 74 are components of the host computing device 12, functionality implemented by the applications 40, 74 may be attributed to the host computing device 12 generally. Moreover, in examples where the applications 40, 74 comprise software instructions that program the processor device 14 to carry out functionality discussed herein, functionality implemented by the applications 40, 74 may be attributed herein to the processor device 14.

It is further noted that while the applications 40, 74 are illustrated as individual components, in other implementations, the functionality described herein with regard to the applications 40, 74 may be implemented via a number of components greater than one.

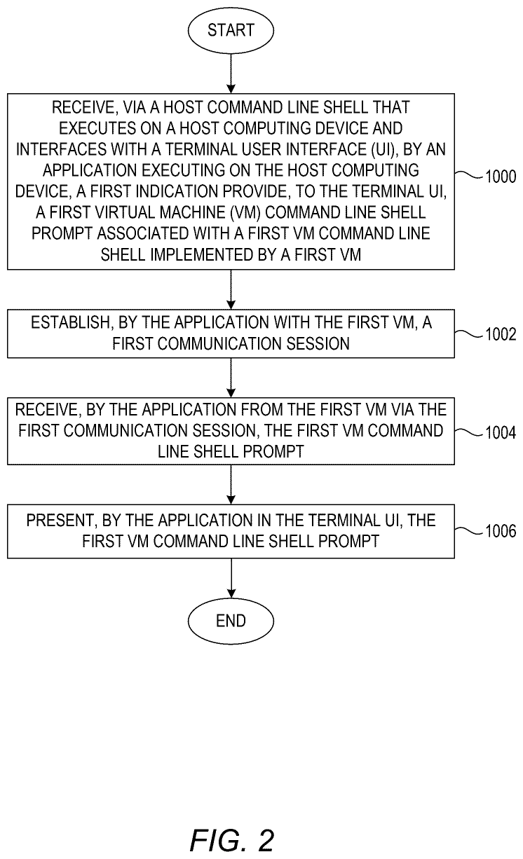

FIG. 2 is a flowchart of a method for implementing a host-based interactive command line environment for communicating with a virtual machine according to some implementations. FIG. 2 will be discussed in conjunction with FIG. 1A. The application 40 receives, via the host command line shell 36 that executes on the host computing device 12 and interfaces with the terminal UI 50, an indication to provide, to the terminal UI 50, the VM command line shell prompt 60 associated with the VM command line shell 28-1E implemented by the VM 22-1E (FIG. 2, block 1000). The application 40 establishes, with the VM 22-1E, the first communication session 56 (FIG. 2, block 1002). The application 40 receives, from the VM 22-1E via the first communication session 56, the VM command line shell prompt 60 (FIG. 2, block 1004). The application 40 presents, in the terminal UI 50, the VM command line shell prompt 60 (FIG. 2, block 1006).

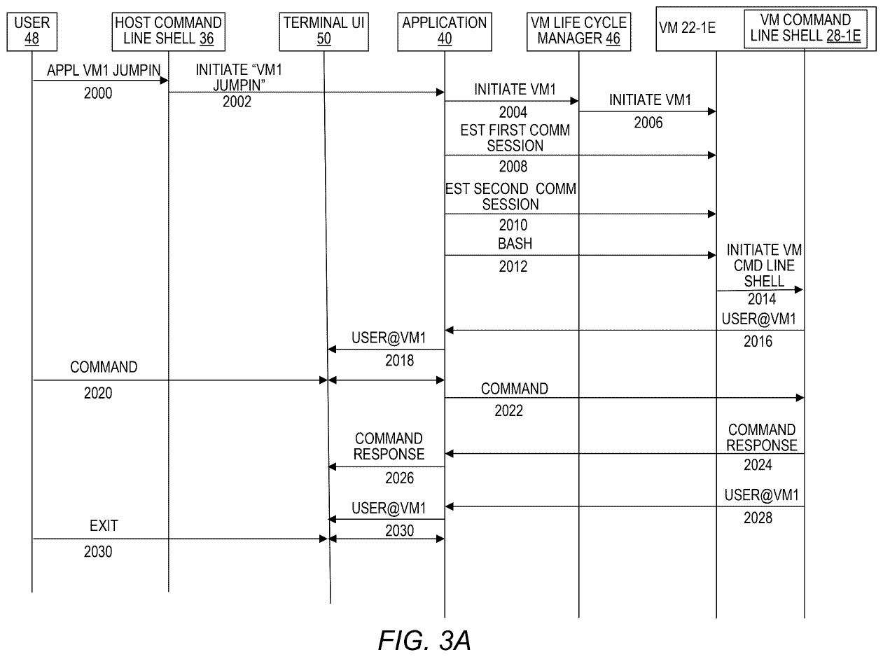

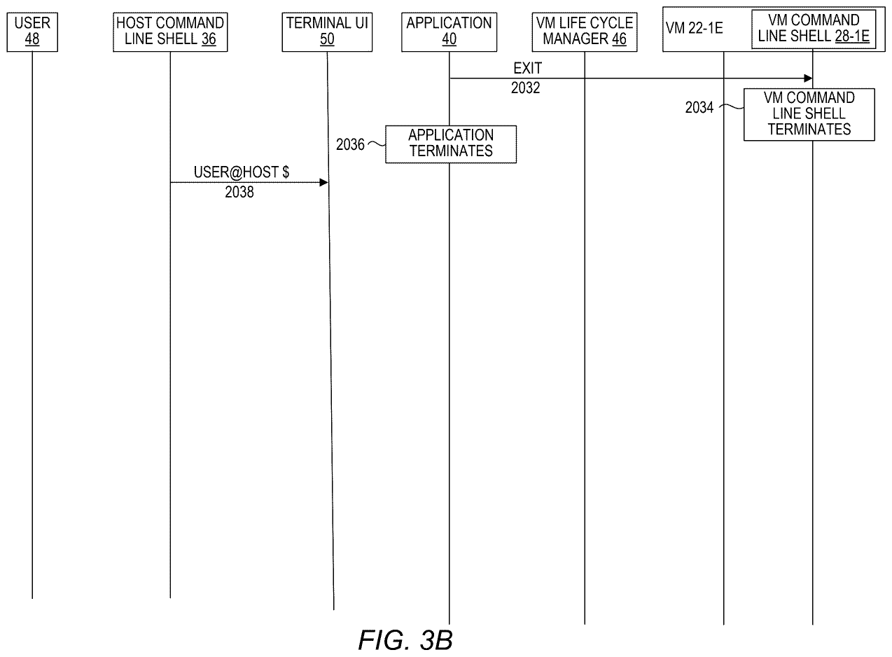

FIGS. 3A-3B illustrate a message sequence diagram illustrating messages communicated between and actions taken by certain components illustrated in FIGS. 1A-1C to implement a host-based interactive command line environment for communicating with a virtual machine according to some implementations. In this example the user 48 is presented with the terminal UI 50 and the host command line shell prompt. The user 48 submits user input adjacent the host command line shell prompt and presses the enter key. The user input comprises the instruction “APPL VM1 JUMPIN” (FIG. 3A, step 2000). In response, the host command line shell 36 initiates the application 40 and provides the application 40 the parameter “VM1 JUMPIN” (FIG. 3A, step 2002). The application 40 initiates and now has control of the terminal UI 50 by virtue of being executed by the host command line shell 36. The application 40 determines that the VM 22-1 is not running on the host computing device 12 and is stored on the storage device 20. The application 40 causes the executing VM 22-1E to be initiated from the VM 22-1 by sending a command to the VM life cycle manager 46 to initiate the VM 22-1E from the VM 22-1 (FIG. 3A, step 2004). The VM life cycle manager 46 starts the VM 22-1E from the VM 22-1 (FIG. 3A, step 2006). The VM 22-1E initiates and automatically initiates the first communication session agent 24-1E and the second communication session agent 26-1E.

The first communication session agent 42 establishes the first communication session 56 with the first communication session agent 24-1E (FIG. 3A, step 2008). The second communication session agent 44 establishes the second communication session 58 with the second communication session agent 26-1E (FIG. 3A, step 2010).

The application 40 sends a “BASH” command to the VM 22-1E via the first communication session 56 to the VM 22-1E (FIG. 3A, step 2012). The VM 22-1E initiates the VM command line shell 28-1E (FIG. 3A, step 2014). The application 40 receives, from the VM 22-1E via the first communication session 56, the VM command line shell prompt 60 (FIG. 3A, step 2016). The application 40 presents the VM command line shell prompt 60 in the terminal UI 50 (FIG. 3A, step 2018).

The user 48 may now submit commands to the VM 22-1E via the terminal UI 50. In this example, the user 48 enters a command known to BASH to the VM command line shell prompt 60 and presses the enter key (FIG. 3A, step 2020). The application 40 receives the command and sends the command to the VM command line shell 28-1E via the first communication session 56 (FIG. 3A, step 2022). The VM command line shell 28-1E receives the command and implements the command on the VM 22-1E. The VM command line shell 28-1E sends the response generated by the command to the application 40 (FIG. 3A, step 2024).

The application 40 receives the command response and presents the response in the terminal UI 50 (FIG. 3A, step 2026). The VM command line shell 28-1E immediately, after sending the response to the application 40, sends the VM command line shell prompt to the application 40 (FIG. 3A, step 2028). The application 40 receives the VM command line shell prompt and presents the VM command line shell prompt in the terminal UI 50 (FIG. 3A, step 2026). Steps 2020-2030 may be repeated continuously as suitable or desirable by the user 48 to accomplish the desired tasks on the VM 22-1E.

At some point in time the use 48 has completed the desired tasks on the VM 22-1E and submits as user input an “EXIT” command (FIG. 3A, step 2030). Referring now to FIG. 3B, the application 40 receives the EXIT command and sends the EXIT command to the VM command line shell 28-1E via the first communication session 56 (FIG. 3A, step 2032). The VM command line shell 28-1E receives the EXIT command and terminates (FIG. 3A, step 2034). The application 40 terminates (FIG. 3A, step 2036). The termination of the application 40 returns control of the terminal UI 50 to the host command line shell 36 which, in response, sends the host command line shell prompt to the terminal UI 50 (FIG. 3A, step 2038). A subsequent command entered by the user 48 will be processed by the host command line shell 36.

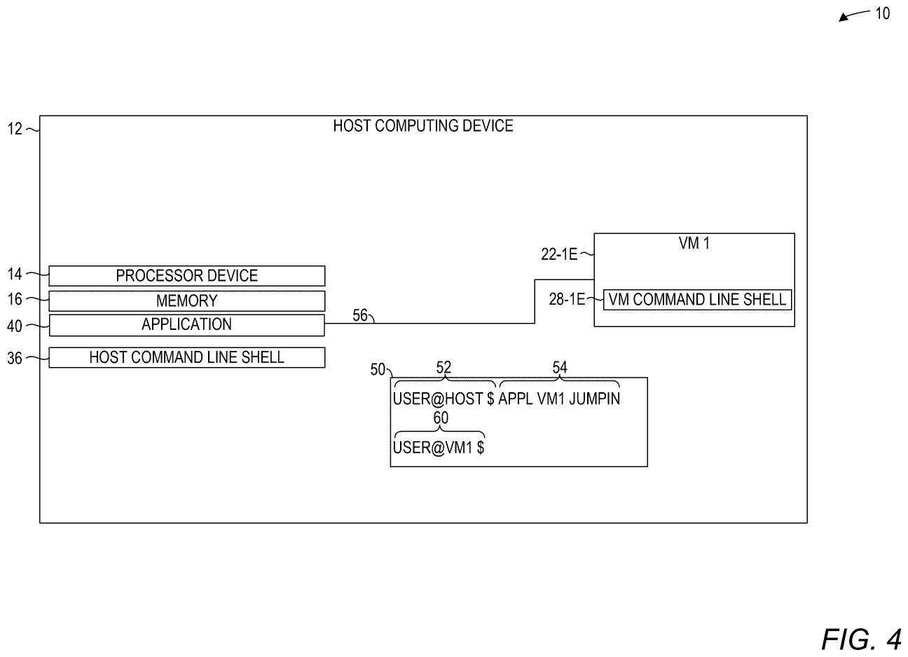

FIG. 4 is a simplified block diagram of the environment 10 illustrated in FIGS. 1A-1C according to one implementation. The environment 10 includes the host computing device 12 and that includes the memory 16 and the processor device 14. The processor device 14 is to receive, via the host command line shell 36 executing on the host computing device 12 that interfaces with the terminal UI 50, by the application 40 executing on the host computing device 12, the indication “AAPL VM1 JUMPIN” to provide, to the terminal UI 50, the VM command line shell prompt 60 associated with the VM command line shell 29-1E implemented by the VM 22-1E. The processor device 14 is further to establish, by the application 40 with the VM 22-1E, the first communication session 56. The processor device 14 is further to receive, by the application 40 from the VM 22-1E via the first communication session 56, the VM command line shell prompt 60, and present, by the application 40 in the terminal UI 50, the VM command line shell prompt 60.

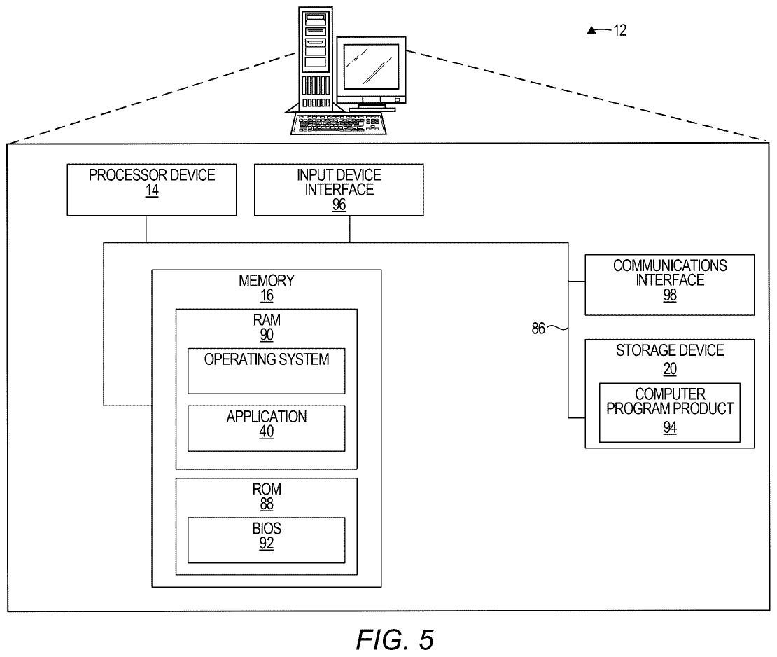

FIG. 5 is a block diagram of the host computing device 12 suitable for implementing examples according to one example. The host computing device 12 may comprise any computing or electronic device capable of including firmware, hardware, and/or executing software instructions to implement the functionality described herein, such as a computer server, a desktop computing device, a laptop computing device, or the like. The host computing device 12 includes the processor device 14, the system memory 16, and a system bus 86. The system bus 86 provides an interface for system components including, but not limited to, the system memory 16 and the processor device 14. The processor device 14 can be any commercially available or proprietary processor.

The system bus 86 may be any of several types of bus structures that may further interconnect to a memory bus (with or without a memory controller), a peripheral bus, and/or a local bus using any of a variety of commercially available bus architectures. The system memory 16 may include non-volatile memory 88 (e.g., read-only memory (ROM), erasable programmable read-only memory (EPROM), electrically erasable programmable read-only memory (EEPROM), etc.), and volatile memory 90 (e.g., random-access memory (RAM)). A basic input/output system (BIOS) 92 may be stored in the non-volatile memory 88 and can include the basic routines that help to transfer information between elements within the host computing device 12. The volatile memory 90 may also include a high-speed RAM, such as static RAM, for caching data.

The host computing device 12 may further include or be coupled to a non-transitory computer-readable storage medium such as the storage device 20, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 20 and other drives associated with computer-readable media and computer-usable media may provide non-volatile storage of data, data structures, computer-executable instructions, and the like.

A number of modules can be stored in the storage device 20 and in the volatile memory 90, including an operating system and one or more program modules, such as the application 40, which may implement the functionality described herein in whole or in part. All or a portion of the examples may be implemented as a computer program product 94 stored on a transitory or non-transitory computer-usable or computer-readable storage medium, such as the storage device 20, which includes complex programming instructions, such as complex computer-readable program code, to cause the processor device 14 to carry out the steps described herein. Thus, the computer-readable program code can comprise software instructions for implementing the functionality of the examples described herein when executed on the processor device 14. The processor device 14, in conjunction with the application 40 in the volatile memory 90, may serve as a controller, or control system, for the host computing device 12 that is to implement the functionality described herein. An operator, such as the user 48, may also be able to enter one or more commands through a keyboard (not illustrated), a pointing device such as a mouse (not illustrated), or a touch-sensitive surface such as a display device. Such input devices may be connected to the processor device 14 through an input device interface 96 that is coupled to the system bus 86 but can be connected by other interfaces such as a parallel port, an Institute of Electrical and Electronic Engineers (IEEE) 1394 serial port, a Universal Serial Bus (USB) port, an IR interface, and the like. The host computing device 12 may also include a communications interface 98, such as an Ethernet transceiver and/or a Wi-Fi transceiver, or the like, suitable for communicating with a network as appropriate or desired.

Individuals will recognize improvements and modifications to the preferred examples of the disclosure. All such improvements and modifications are considered within the scope of the concepts disclosed herein and the claims that follow.

What is claimed is:

1. A method, comprising:
receiving, via a host command line shell that executes on a host computing device and interfaces with a terminal user interface (UI), by an application executing on the host computing device, a first indication to provide, to the terminal UI, a first virtual machine (VM) command line shell prompt associated with a first VM command line shell implemented by a first VM;
establishing, by the application with the first VM, a first communication session;
receiving, by the application from the first VM via the first communication session, the first VM command line shell prompt; and
presenting, by the application in the terminal UI, the first VM command line shell prompt.

2. The method of claim 1, further comprising causing, by the application, the first VM to initiate on the host computing device.

3. The method of claim 1, further comprising:
subsequent to presenting the first VM command line shell prompt, receiving, by the application, user input submitted in the terminal UI adjacent to the first VM command line shell prompt;
sending, by the application, the user input to the first VM via the first communication session;
receiving, by the application from the first VM, information generated by the first VM in response to the user input; and
presenting, by the application in the terminal UI, the information.

4. The method of claim 3 wherein the information is presented in the terminal UI below the user input such that the user input and the information are presented concurrently.

5. The method of claim 3, further comprising:
subsequent to presenting the information in the terminal UI, presenting, by the application, the first VM command line shell prompt below the information.

6. The method of claim 1, further comprising:
subsequent to presenting the first VM command line shell prompt, receiving, by the application, user input submitted in the terminal UI adjacent to the first VM command line shell prompt, the user input requesting a presentation of directory names of a file system of the first VM;
sending, by the application, the user input to the first VM via the first communication session;
obtaining, by the application, directory names of a file system of the host computing device;
sending, by the application, the directory names of the file system of the host computing device to the first VM;
receiving, by the application from the first VM, information identifying the directory names of the file system of the first VM and identifying the directory names of the file system of the host computing device; and
presenting, by the application, the information in the terminal UI.

7. The method of claim 6, further comprising:
prior to obtaining the directory names of the file system of the host computing device, receiving, by the application from the first VM, a request to obtain the directory names of the file system of the host computing device.

8. The method of claim 1, further comprising:
subsequent to presenting the first VM command line shell prompt, receiving, by the application, user input submitted in the terminal UI adjacent to the VM command line shell prompt;
determining, by the application, that the user input requests that the application inhibit communication with the first VM via the terminal UI;
terminating, by the application, the first communication session with the first VM; and
causing, by the application, a host command line shell prompt of the host command line shell to be presented in the terminal UI.

9. The method of claim 8, further comprising:
subsequent to causing the host command line shell prompt of the host command line shell to be presented in the terminal UI, receiving, via the host command line shell by the application, a second indication to provide, to the terminal UI, a second VM command line shell prompt associated with a second VM command line shell implemented by a second VM that is different from the first VM;
establishing, by the application with the second VM, a second communication session;
sending, by the application to the second VM via the second communication session, an instruction to initiate the second VM command line shell;
receiving, by the application from the second VM via the second communication session, the second VM command line shell prompt; and
presenting, by the application in the terminal UI, the second VM command line shell prompt.

10. The method of claim 1, wherein the terminal UI is a text-based user interface.

11. The method of claim 10, wherein the text-based user interface is devoid of bit-mapped graphics.

12. The method of claim 1, wherein the first communication session is a secure shell (SSH) communication session.

13. The method of claim 1, wherein the first communication session comprises a text-based communication session, and further comprising:
establishing, by the application with the first VM, a second communication session, wherein the second communication session is a graphical based communication session.

14. The method of claim 1, further comprising:
prior to establishing the first communication session, causing, by the application, the first VM to initiate on the host computing device.

15. The method of claim 1, further comprising:
prior to receiving, by the application from the first VM via the first communication session, the first VM command line shell prompt, sending, by the application to the first VM via the first communication session, an instruction to initiate the first VM command line shell.

16. The method of claim 1, further comprising:
prior to receiving, by the application, the first indication, presenting, by the host command line shell, a host command line shell prompt in the terminal UI;
receiving, by the host command line shell, user input submitted in the terminal UI adjacent to the host command line shell prompt, the user input comprising a request to execute the application that includes an identifier of the first VM; and
in response to receiving the user input, initiating, by the host command line shell, the application and providing the application the first indication to provide, to the terminal UI, the first VM command line shell prompt associated with the first VM command line shell implemented by the first VM.

17. A host computing device, comprising:
a memory; and
a processor device coupled to the memory to:
receive, via a host command line shell that executes on the host computing device that interfaces with a terminal user interface (UI), by an application executing on the host computing device, a first indication to provide, to the terminal UI, a first virtual machine (VM) command line shell prompt associated with a first VM command line shell implemented by a first VM;
establish, by the application with the first VM, a first communication session;
receive, by the application from the first VM via the first communication session, the first command line shell prompt; and
present, by the application in the terminal UI, the first VM command line shell prompt.

18. The host computing device of claim 17, wherein the processor device is further to:
subsequent to presenting the first VM command line shell prompt, receive, by the application, user input submitted in the terminal UI adjacent to the first VM command line shell prompt;
send, by the application, the user input to the first VM via the first communication session;
receive, by the application from the first VM, information generated by the first VM in response to the user input; and
present, by the application in the terminal UI, the information.

19. A non-transitory computer-readable storage medium that includes executable instructions to cause a processor device to:
receive, via a host command line shell that executes on the host computing device that interfaces with a terminal user interface (UI), by an application executing on the host computing device, a first indication to provide, to the terminal UI, a first virtual machine (VM) command line shell prompt associated with a first VM command line shell implemented by a first VM;
establish, by the application with the first VM, a first communication session;
receive, by the application from the first VM via the first communication session, the first command line shell prompt; and
present, by the application in the terminal UI, the first VM command line shell prompt.

20. The non-transitory computer-readable storage medium of claim 19, wherein the instructions are further to cause the processor device to:
subsequent to presenting the first VM command line shell prompt, receive, by the application, user input submitted in the terminal UI adjacent to the first VM command line shell prompt;
send, by the application, the user input to the first VM via the first communication session;
receive, by the application from the first VM, information generated by the first VM in response to the user input; and
present, by the application in the terminal UI, the information.
